(19) United States
(12) Patent Application Publication
(10) Pub. No.: US 2007/0148074 A1
(43) Pub. Date: Jun. 28, 2007

(54) Nanoparticle based stabilization of ir fluorescent dyes

(76) Inventors: Mostafa Sadoqi, Flushing, NY (US); Jun Shao, West Babylon, NY (US); Vishal Saxena, Quincy, MA (US); Sunil Kumar, Riverdale, NY (US)

Correspondence Address: MORGAN & FINNEGAN, L.L.P., 3 WORLD FINANCIAL CENTER, NEW YORK, NY, 10281-2101, US

(21) Appl. No.: 10/542,185

(22) PCT Filed: Jan. 15, 2004
(86) PCT No.: PCT/US04/01472

§ 371 Date: Oct. 19, 2006

Related U.S. Application Data
(60) Provisional application No. 60/440,658, filed on Jan. 16, 2003.

(51) Int. Cl. C01B 25/26

(52) U.S. Cl. 423/314

(57) ABSTRACT

This invention relates to a highly effective nanoparticle system for stabilizing near-infrared (near-IR) fluorescent dyes such as indocyanine (ICG) in order to enhance the dye's utility for biomedical application. This invention further relates to nanoparticles comprised of biodegradable polymer materials such as poly(dl-lactide-co-glycolide)(PLGA). The invention also relates to methods of preparing the nanoparticle-entrapped dyes, as well as methods for using them in bioimaging, diagnosis, and treatment of disease. The present invention also relates to compositions and kits comprising nanoparticle-entrapped dyes.

### TECHNICAL FIELD OF THE INVENTION

This invention relates to stabilization of dyes, nanoparticles and nanoparticle-entrapped dyes, and methods of making them. The nanoparticles of the invention protect dyes, particularly near-infrared (near-IR) fluorescent dyes, from degradation and aggregation in vitro and in vivo, thereby significantly enhancing their half-life and utility for a broad variety of applications. This invention further provides nanoparticles comprised of biodegradable polymers such as poly(dl-lactide-co-glycolide) (PLGA). This invention also provides nanoparticles for use as biomarkers, targeting and photodynamic agents in biomedical applications.

### BACKGROUND OF THE INVENTION

Recent studies of near-IR cyanine dyes have proven their usefulness in numerous analytical applications. Near-IR dyes are known to have strong absorption bands in the long wavelength region of the spectrum, and many have large molar absorptivities. The near-IR dyes are particularly useful as biomarkers for in vivo imaging due to their absorption and emission properties in the near-IR region of the spectrum from about 600 to 1000 nm. Most biomolecules do not absorb and fluoresce in this region; therefore, the dye is relatively free from body's intrinsic background interference, greatly enhancing the dye's selectivity.

The tricarbocyanine dye, indocyanine green (ICG), is an example of an infrared dye widely used in clinical applications that has been approved by the United States Food and Drug Administration (FDA). One important characteristics of ICG, however, has proven to be a handicap for clinical applications: the poor stability of the dye in solution. Instability of ICG solutions has been shown to depend upon the nature of the solvent, the concentration of the dye, the ionic content of the solution, and its temperature and light exposure during storage. In aqueous solution and blood plasma, ICG has been observed to undergo physicochemical transformations attributed to aggregation and irreversible degradation. Such changes have been shown to result in decreased light absorption, decreased fluorescence, and a shift of the wavelength of maximum absorption.

In addition to its instability in aqueous solutions, ICG fluorescence demonstrates a complex dependence on dye concentration. Dye fluorescence increases as a function of concentration to a maximum beyond which addition of more dye results in a decrease of the fluorescence intensity. Some factors affecting the fluorescence of ICG as a function of concentration include the formation of weakly fluorescent aggregates at high concentration, concentration quenching (i.e. self-quenching), and overlap of the absorption and emission spectra of the dye which results in reabsorption of the emitted fluorescence by dye molecules.

Furthermore, ICG has an elimination half-life of 2-4 minutes in the human body when administered intravenously, due to the body's own natural elimination mechanisms.

Therefore, due to dyes such as ICG's susceptibility to degrade in solution and to form aggregates with increased concentration, a delivery system that would provide stability in aqueous solution and prevent aggregate formation is of therapeutic interest.

Earlier work for stabilization of ICG has centered on the addition of proteins as stabilizing agents (See, for example, Moody, E. D., Viskari, P. J. and Colyer, C. L., Non-covalent labeling of human serum albumin with indocyanine green: a study by capillary electrophoresis with diode laser-induced fluorescence detection. J. Chrom. B: Biomed. Sci. App. 729 1-2 (1999), pp. 55-64; Maarek, J.-M. I. et al. Fluorescence of indocyanine green in blood: intensity depedence on concentration and stabilization with sodium polyaspartate. J. Photochem. Photobiol. B. Biol., 65 (2001), pp. 157-164.).

Alternative approaches involve delivery systems based upon biodegradable colloidal carriers. In recent years, polymer nanoparticles (solid colloidal particles ranging from 1 to 1000 nm in size) have been used as colloidal drug carriers for controlled drug delivery via intravenous, ocular and oral administration routes. Polymers such as poly(dl-lactide-co-glycolide) (PGLA) are widely used in pharmaceutical applications due to their biocompatibility and biodegradability (See, for example, U.S. Pat. Nos. 6,447,796 B1 and 6,312,732).

Therefore, an object of the present invention is the development of a nanoparticle system made of polymeric materials that protect dyes such as near-IR dyes from degradation and aggregation in aqueous solution.

Yet another object of the invention is the preparation of polymeric nanoparticles that efficiently entrap IR fluorescent dyes.

A further object of the present invention is the use of compositions comprising the nanoparticle-dye system in bioimaging, diagnosis, and treatment of disease.

Yet another object of the invention is an injectable delivery system providing stability of the IR dye in aqueous solution and prevention of aggregate formation in vivo.

Another object of the present invention is the production of kits containing the nanoparticle-dye system of the invention.

### SUMMARY OF THE INVENTION

This invention relates to the use of polymer nanoparticles to entrap fluorescent dyes and increase their stability in vitro and in vivo. In a preferred embodiment the nanoparticles are comprised of the biodegradable colloidal polymer, PLGA.

The polymeric nanoparticles of the present invention have a diameter of about 1 nm to about 1000 nm. Preferably, the nanoparticle diameters range in size from about 50 to 800 nm, and more preferably from about 100 to 350 nm. The nanoparticles of the invention are of optimal size for in vivo applications and for reduction of degradation and aggregation of IR dyes.

The present invention further relates to nanoparticles made of biocompatible and biodegradable polymeric materials such as PLGA. The invention also contemplates that other dye entrapping polymeric materials having similar biocompatible properties would work equally as well, among which, illustratively, are polylactic acid (PLA) and polyglycolic acid (PGA).

The present invention further provides that the nanoparticles entrap fluorescent dyes, particularly, near-IR fluorescent dyes. Preferred near-IR dyes include, but are not limited to, the tricarbocyanine dye, ICG.

The present invention also relates to a nanoparticle-dye complex further comprising targeting molecules or agents which facilitate the targeted delivery of the nanoparticle-dye complexes to a specific tissue or site in vivo.

The invention also relates to nanoparticles which are coated with agents such as polyethylene glycol (PEG) to further increase the stability of the nanoparticle-dye complex in vivo for imaging and photodynamic therapy applications, among others.

The present invention further relates to methods of preparing the nanoparticles containing substantive amounts of dye and/or an imaging substance, as high as about 10 to about 75%. The methods disclosed herein optimize entrapment of the dye or imaging substance, from about 2% to about 74%, and produce nanoparticle-dye complexes that maintain the activity of co-incorporated molecules, are structurally stable, and are less than 1000 nm in diameter.

The present invention further relates to methods of using the nanoparticle-dye system in diagnosis and bioimaging.

The present invention also relates to methods of treating diseases, ailments and conditions based upon the nanoparticle-facilitated delivery of IR-dyes. For example, the present invention provides pharmaceutical compositions and methods for killing tumor cells in vivo. The invention also relates to co-entrapment of additional therapeutic agents that augment the therapeutic effect.

The present invention further provides pharmaceutical compositions comprising the nanoparticle-dye complexes, and a pharmaceutically acceptable carrier.

The present invention also relates to kits containing the nanoparticle-dye complexes of the invention for a variety of clinical applications.

### BRIEF DESCRIPTION OF THE FIGURES

FIG. 1: Relative stabilities of Indocyanine green (IR-125) loaded nanoparticles as compared with Indocyanine green aqueous solutions under various temperature and light exposure conditions.

FIG. 2: Atomic Force Microscopic images of ICG (IR-125) loaded PLGA nanoparticles.

FIG. 3: Evaluation of particle size through Atomic Force Microscopy of ICG (IR-125) loaded PLGA nanoparticles.

FIG. 4: Intracellular uptake of Indocyanine green (ICG), by C-33A cancer cell line, when incubated with ICG solution and ICG loaded nanoparticle suspension.

FIG. 5: Relative intracellular uptake of indocyanine green (ICG), by C-33A and B16-F10 cancer cell lines, when incubated with ICG loaded nanoparticle suspension.

FIG. 6: Effect of initial PEG concentration used for nanoparticle coating on the amount of PEG coated on the nanoparticles.

### DETAILED DESCRIPTION OF THE INVENTION

The present invention relates to the discovery that polymeric nanoparticles ranging in diameter from about 1 to 1000 nm efficiently entrap imaging substances such as dyes, particularly, near-IR dyes, and substantially enhance their half-life and stability in vitro and in vivo. The nanoparticles of the invention are made of biocompatible and biodegradable polymers such as PLGA.

Nanoparticles

The nanoparticles of the invention range in size from about 1 nm to about 1000 nm in diameter, but are not necessarily limited to 1000 nm. The size of the nanoparticles may extend into the micrometer range for certain applications or routes of administration, such as, for example, for use as implants. Preferred nanoparticle diameters range from about 50 to 800 nm, and more preferably from about 100 to 350 nm. One skilled in the art would readily recognize that the size of the nanoparticle may vary depending upon the method of preparation, clinical application, and imaging substance used.

The present invention further relates to nanoparticles made of biocompatible and biodegradable polymeric materials. In a preferred embodiment, the nanoparticles are made of PLGA. PLGA, per se, is FDA approved and has been used in drug delivery systems for a variety of drugs via numerous routes of administration including, but not limited to, subcutaneous, intravenous, ocular, oral and intramuscular. The PLGA nanoparticles made according to the invention form spherical or nearly-spherical matrix structures that embed or entrap (i.e. encapsulate) dye or other substances or molecules within the spaces of the matrix during the entrapment process.

Although PLGA is a preferred material, this invention contemplates that other polymeric colloidal carriers would work equally as well. Examples of such polymers include, but are not limited to, PLA, PGA, Chitosan, and Albumin.

In a further embodiment, the nanoparticles of the invention entrap fluorescent dyes of the general class known as cyanine dyes, with emission wavelengths of between 550 nm to 1000 nm. These dyes may contain additional chemical groups that influence the spectral properties of the dyes. Preferred dyes for use in the invention are tricarbocyanine dyes, such as indocyanine green (ICG). The sodium iodide salt of ICG (ICG-NaI) is used in medical diagnosis, such as for the evaluation of cardiac output, liver function, microcirculation of skin flaps, and visualization of the retinal and choroidal vasculatures. In addition, ICG is useful in photodynamic therapy.

An important motivation for using ICG in the invention is that its absorption peak (˜800 nm) and its most intense fluorescence (˜820 nm) are at wavelengths for which blood and other tissues are relatively transparent. As a result, ICG can conveniently be measured in blood samples or transcutaneously by spectrophotometry or spectrofluorometry. Furthermore, because ˜95% of the dye in plasma is protein-bound, it remains largely intravascular, which is important in clinical applications where dye diffusion out of the vascular compartment can confound interpretation of results.

In addition to ICG, the nanoparticle system of the invention could be used to stabilize other near-IR fluorescent dyes, or other fluorescent dye classes, or related dyes, or imaging substances that are particularly suited for the uses described herein. One skilled in the art would be able to select appropriate dyes based upon their desired emission and absorption properties and the specific clinical or biological application for which they are needed. The nanoparticle technology described herein would work equally as well to stabilize and enhance the utility of such dyes.

In yet a further embodiment, the nanoparticles of the invention may contain targeting molecules that facilitate localized delivery of the nanoparticle-dye complex to a specific tissue or cell-type. This embodiment is of particular importance for therapeutic applications, such as the treatment of cancer. Examples of targeting molecules include, but are not limited to, antibodies or antibody fragments, proteins or polypeptides, polysaccharides, DNA, RNA, chemical moieties, magnetic moieties and any combination thereof. In addition, cell-specific surface markers (such as CD4, CD8, CD19, etc) or specific receptors (such as CD40, transferrin, folate, or mannose) could be targeted by attaching a specific antibody or ligand to the surface of the nanoparticle.

This invention also contemplates that other pharmaceutical agents or drugs or chemicals may be co-entrapped or encapsulated in the nanoparticle system to further augment a therapeutic effect or other intended purpose.

In a preferred embodiment, the present invention relates to nanoparticles that contain, or are coated with, substances or agents that further increase the stability of the nanoparticle-dye complex. For example, coating nanoparticles with substances such as PEG may further increase the stability and prolong the half-life of the nanoparticles in vivo. Studies have shown that the elimination half-life of PLGA nanoparticles that were not coated with PEG was approximately 12-14 minutes in mice. In contrast, the PEG-coated PLGA nanoparticles had prolonged circulation times in vivo, with an elimination half-life of 4-5 hrs in mice. (see, Ya-Ping Li, Yuan-Ying Pei, Xian-Ying Zhang, Zhou-Hui Gu, Zhao-Hui Zhou, Wei-Fang Yuan, Jian-Jun Zhou, Jian-Hua Zhu and Xiu-Jian Gao. PEGylated PLGA nanoparticles as protein carriers: synthesis, preparation and biodistribution in rats, J. Controlled Release, Volume 71, Issue 2, 2 Apr. 2001, Pages 203-211).

In another embodiment, the nanoparticles can be injected locally in the tissue or be locally implanted. The nanoparticles may stay at the injection site for a few days to months and gradually release the loaded content while the particles are degraded over the time period depending upon the implantation site. Studies of microparticles in in vitro simulated environments and in vivo in animal models have shown that the particles stay at the implantation site for over a month (see, for example, Fangjing Wang, Timothy Lee and Chi-Hwa Wang, PEG modulated release of etanidazole from implantable PLGA/PDLA discs, Biomaterials, Volume 23, Issue 17, September 2002, Pages 3555-3566; R. V. Diaz, M. Llabrés and C. Évora, One-month sustained release microspheres of ¹²⁵I-bovine calcitonin: In vitro-in vivo studies, J. of Controlled Release, Volume 59, Issue 1, 1 May 1999, Pages 55-62; T. Hickey, D. Kreutzer, D. J. Burgess and F. Moussy, Dexamethasone/PLGA microspheres for continuous delivery of an anti-inflammatory drug for implantable medical devices, Biomaterials, Volume 23, Issue 7, 1 Apr. 2002, Pages 1649-1656; Christian Witt and Thomas Kissel, Morphological characterization of microspheres, films and implants prepared from poly(lactide-co-glycolide) and ABA triblock copolymers: is the erosion controlled by degradation, swelling or diffusion?, European J. Pharmaceutics Biopharmaceutics, Volume 51, Issue 3, May 2001, Pages 171-181).

Nanoparticle Preparation

The present invention also relates to methods of preparing nanoparticles comprising generally, of polymeric materials such as PLGA, and polyvinyl alcohol (PVA). The ICG dye is preferably IR-125, a laser grade dye. In a preferred embodiment, the method involves dissolving the PLGA in acetonitrile to form a solution, and dissolving the IR dye in methanol to obtain a second solution.

The PVA is added to distilled water to form a 4% PVA solution. This aqueous solution is then filtered, for example, with a 0.22μ syringe filter.

Following the above steps, 2 parts of the PLGA solution, and 1 part of the IR-125 solution are mixed to form a homogenous PLGA/IR-125 solution. This homogenous solution is then added drop by drop into 15 parts of the aqueous PVA solution (4% w/v) using 1000 μl pipette tips with an internal diameter of 0.03 inches, with continuous stirring at 700 rpm using a laboratory magnetic stirrer. In some instances, the speed with which the homogenous solution is dropped into the PVA solution and stirring speed may have some effect on nanoparticle size. Very slow speeds may lead to bigger size ranges, and faster speeds to smaller size ranges. One skilled in the art would be able to determine an optimal speed to obtain the preferred size of nanoparticle.

The nanoparticle suspension formed is then stirred for an additional 10 minutes at 700 rpm, and then centrifuged for 20 minutes at 16,000 g.

After centrifugation the supernatant is discharged and the nanoparticle precipitate is washed with same volume of distilled water as the supernatant and centrifuged again at 16,000 g for 6 min. The washing step is repeated three times. The washed nanoparticles can then be freeze-dried and stored preferably at 0 to −20° C., until further use.

The methods of preparation described herein optimize dye entrapment and produce nanoparticulate complexes that maintain the activity and structural stability of co-incorporated molecules.

The weight ratio of polymer: dye to form the nanoparticles of the invention is preferably in the range of about 100:1 to about 1000:1 to provide efficient entrapment and stability of the dye. In a more preferred embodiment, the ratio is about 800:1 to about 1000:1.

As mentioned above, the nanoparticle-entrapped dye system, may contain targeting molecules to deliver the nanoparticles and dye to specific tissue sites or cells in vivo. For example, cell specific monoclonal antibodies could be attached to the nanoparticles in order to target the IR dye or other agent to a specific cell type or organ in vivo, including tumor cells. Alternatively, chemical agents, cell-specific peptides, or ligands, may be incorporated in the nanoparticle, or used to modify one or more of the polymer constituents. For example, after entrapment of the dye in the nanoparticles, ligands may be added directly to the exterior surface of the nanoparticle-dye complexes. The stability of the nanoparticle and presence of reactive functional groups on the polymer chain on the surface allow ligands to be directly added to their exterior surface. Examples include, but are not limited to, the attachment of PEG chains on the surface of the nanoparticles to prolong circulation of the nanoparticles in vivo; thus, increasing passive targeting to tissues or cells such as tumors.

As mentioned above, many ligands may be employed for this step of nanoparticle preparation, depending on the cell-type targeted for nanoparticle delivery. Those skilled in the art would readily recognize that any ligand which enhances uptake or localization in a given tissue may be an appropriate candidate for targeting the nanoparticle-entrapped dye system of the invention.

Compositions Comprising Nanoparticles and IR Dyes

The nanoparticle system of the invention may be formulated in a variety of ways depending on the application. Such applications include, but are not limited to, biomedical and therapeutic applications. The invention therefore includes within its scope compositions comprising at least one nanoparticle-dye complex formulated for use in human or veterinary medicine, or other non-medical application. Such compositions may be presented for use with physiologically acceptable vehicles or excipients, optionally with supplementary medicinal agents. The vehicles and excipients include, but are not limited to, water, glucose, saline, and phosphate buffered saline.

Formulations for injection may be presented in unit dosage form in ampoule, or with an added preservative to prevent contamination, as needed, in multi-dose containers. The composition may take such forms as suspensions, colloidal solutions or emulsions in oily or aqueous vehicles, and may contain formulatory agents such as suspending, stabilizing and/or dispersing agents. For example, parenteral administration may be done by bolus injection or continuous infusion. Alternatively, the nanoparticles may be in powder form for reconstitution with a suitable vehicle, e.g. sterile water, before use.

The nanoparticle-dye complexes of the invention may be formulated for administration in any convenient way. For example, transdermal administration may be in the form of a patch applied on the skin. For oral administration, the pharmaceutical compositions may take the form of, for example, tablets, capsules, powders, solutions, syrups or suspensions prepared by conventional means with acceptable excipients.

Dosages will depend on the extent to which it is possible to present dye, as well as any other active agents, to the target tissue.

Methods of Use of Nanoparticle Stabilized Dyes for Bioimaging

In a further embodiment, compositions comprising nanoparticles may be used for bioimaging. For example, nanoparticles containing a near IR-dye and a targeting molecule will localize the delivery of the nanoparticulate-IR dye system to the site of a tumor and facilitate contact and uptake of the nanoparticles by the tumor cells. After the nanoparticles have been localized to the tumor, the IR dye can be activated with a laser leading to the infra-red wavelength emission (fluorescence) of the IR dye. This fluorescence can be detected with help of a suitable device such as a CCD camera placed outside the body or through endoscopic means.

Therapeutic Applications of Nanoparticles

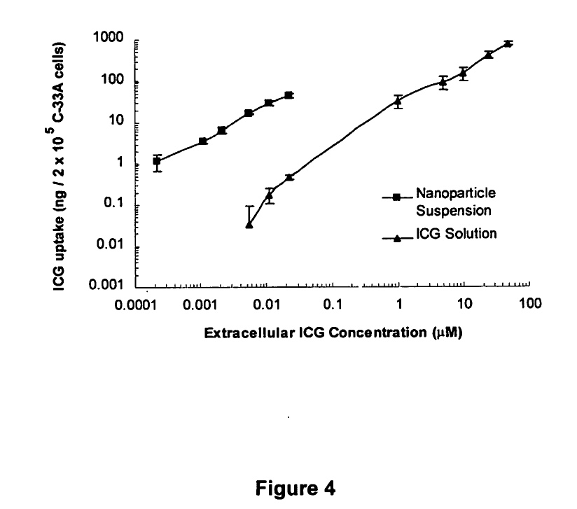

In another embodiment, compositions comprising the nanoparticle system of the invention may be used to treat a subject having a disease including, but not limited to, infectious disease or cancer. The nanoparticle system enhances the uptake by cells such as cancer cells of the dyes, even at lower concentrations than the dye solution alone as shown in FIG. 4. The nanoparticle system provides the advantage of increasing the efficiency of delivery of substances such as ICG to cells both in in vitro and in vivo conditions for imaging and treatment of diseases such as cancer. In another embodiment, cancer treatments may be based on the development of a nanoparticle system that contains a targeting molecule to target and kill cancer cells. One such therapy involving near-IR dyes, is photodynamic tumor therapy. Briefly, nanoparticles containing near IR-dye and a targeting molecule will localize the delivery of the nanoparticle-IR dye complex to the site of a tumor and facilitate contact and uptake of the nanoparticles by the tumor cells. After the nanoparticles have been localized to the tumor, the IR dye can be activated with a laser leading to killing of the tumor cells due to the singlet oxygen production of the dye in the presence of cell water, which is lethal for the tumor cells. The nanoparticles may also co-entrap other active agents to augment the therapeutic efficacy of the nanoparticle-IR dye complex.

All of the references mentioned in the present application are incorporated in their entirety into this application by reference thereto.

The following Examples serve to illustrate further the present invention and are not to be construed as limiting its scope in any way.

### EXAMPLES

### Example 1

### Preparation of IR-125 Loaded PLGA Nanoparticles

Materials:

Poly(dl-lactic-co-glycolic acid) (PLGA) 50:50 and Polyvinyl alcohol (PVA) 88%-89% hydrolyzed were purchased from Sigma (Sigma Chemical Co., St. Louis, Mo.). Indocyanine green (IR-25, laser grade) was obtained from Fisher Scientific (Fisher Scientific Inc., Pittsburgh, Pa.). All organic chemicals and solvents were of reagent grade. Distilled water is filtered by 0.22μ syringe filter (Syrfil-MF Whatman Inc., Clifton, N.J.) before use in the preparation process.

Preparation of IR-125 Loaded PLGA Nanoparticles:

1. Nanoparticles were prepared by modified spontaneous emulsification solvent diffusion method. Briefly, PLGA (800 mg) was dissolved in 16 mL Acetonitrile to form a PLGA solution and IR-125 was dissolved in Methanol to make 0.125 mg/mL IR-125 solution.

2. Also, PVA (4 g) was added to about 100 mL distilled water to form 4% w/v PVA aqueous solution. This aqueous PVA solution is then filtered using 0.22μ syringe filter.

3. To 16 ml of PLGA solution in Acetonitrile, 8 ml of IR-125 solution in Methanol was added to form a homogenous solution PLGA and IR-125 in Acetonitrile-Methanol solvent mixture.

4. This homogenous solution (24 ml) was then added drop-wise into 120 mL of aqueous PVA solution (4% w/v) using 1000 μL pipette tips (VWR International, internal diameter 0.03 inch), with continuous stirring at 700 rpm using a laboratory magnetic stirrer.

5. The nanoparticle suspension formed is then allowed to stir for another 10 minutes at 700 rpm. The suspension was then centrifuged for 20 minutes at 16,000 g.

6. After centrifugation the supernatant was discharged and the nanoparticles precipitate left behind is then washed by using same volume of distilled water as of supernatant and centrifuged at 16,000 g for 6 minutes.

7. The washing process was repeated three times. The washed nanoparticles were then freeze-dried using Freezone 4.5, freeze-drying system (Labconco, Kansas City, Mo.) for 36 hours.

8. The dried nanoparticles were stored at −20° C. in the dark until further use.

TABLE 1
Effects of Nanoparticle Formulation on ICG (IR-125) Incorporation
Table 1 demonstrates various ICG entrapment efficiencies in
nanoparticles prepared by the method in Example 1 using
various amounts of ICG and PLGA in the formulation.

| | Amount of | Amount of | | |
|---|---|---|---|---|
| | Dye in | Polymer in | Dye | Dye |
| Formulation | formulation | formulation | Content | Entrapment |
| Number | (mg) | (mg) | (%) | (%) |
| 1 | 1 | 100 | 0.21 | 9.92 |
| 2 | 5 | 100 | 0.29 | 2.92 |
| 3 | 10 | 100 | 0.17 | 1.14 |
| 4 | 1 | 800 | 0.20 | 74.47 |

### Example 2

### Relative Stabilities of Indocyanine Green (ICG) in Aqueous Solutions Compared with ICG in Nanoparticles Prepared According to the Method Described in Example 1

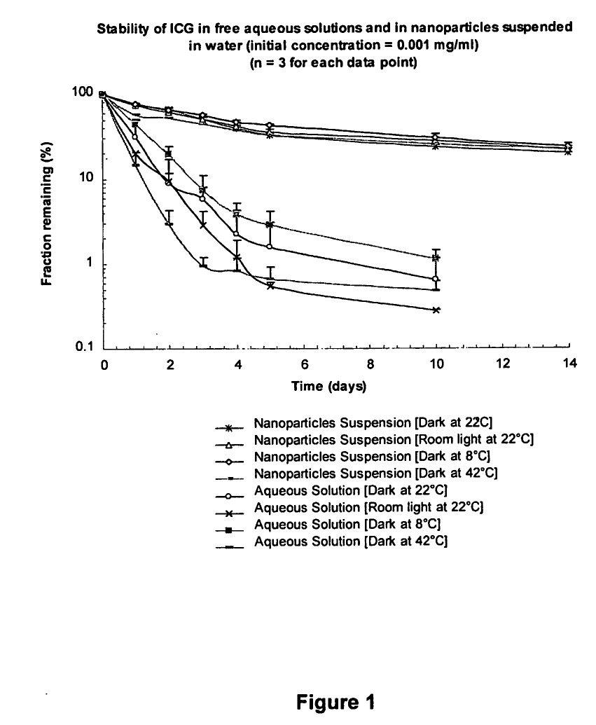

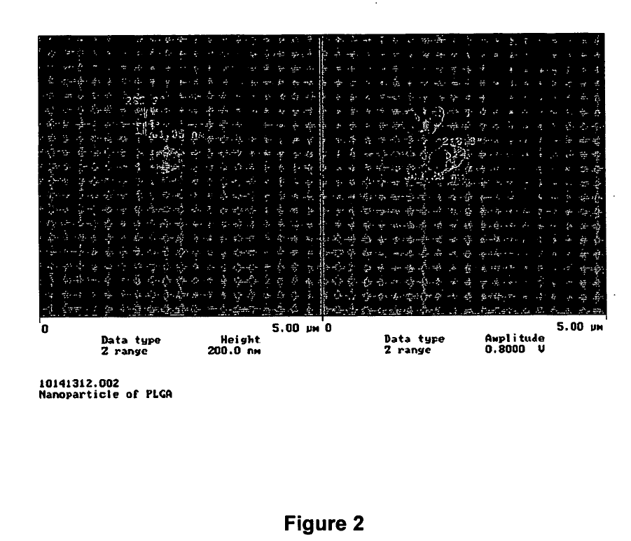

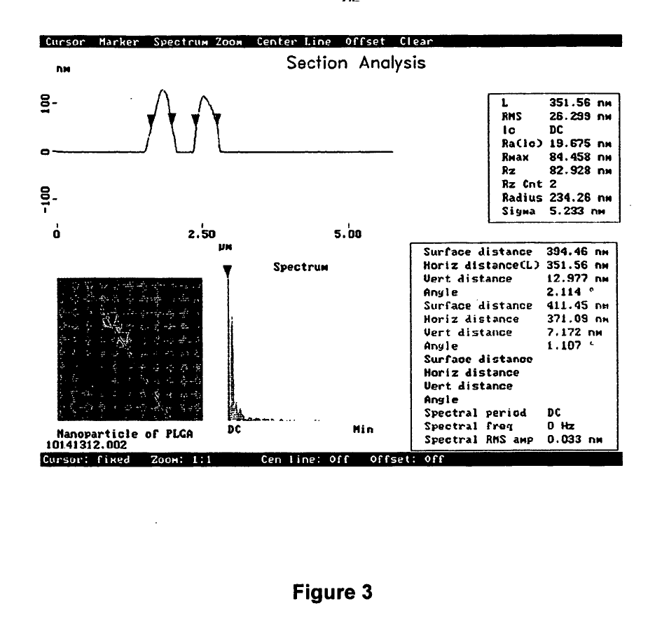

ICG solution of 1 μg/mL was prepared by dissolving 10 mg ICG in 100 mL distilled water and further diluted 100 times in distilled water. About 50 mg ICG nanoparticles were suspended in 100 mL distilled water to obtain 1 μg/mL ICG concentration. The two samples were then placed into several transparent centrifuge tubes and placed at different conditions. At the prefixed time points, the peak fluorescent intensity of these samples was measured at excitation wavelength of 786 nm. The fractions of ICG that remained were calculated by comparing the fluorescent intensity with the initial fluorescent intensity as shown in FIG. 1. Atomic Force Microscopic images of ICG (IR-125) loaded PLGA nanoparticles are shown in FIG. 2. Evaluation of particle size through Atomic Force Microscopy of ICG (IR-125) loaded PLGA nanoparticles is shown in FIG. 3.

### Example 3

### Intracellular Uptake of Indocyanine Green (ICG), by C-33A Cancer Cell line, when Incubated with ICG Solution and ICG Loaded Nanoparticles

Intracellular uptake of Indocyanine green (ICG), by C-33A cancer cell line, when incubated with ICG solution and ICG loaded nanoparticle suspension is shown in FIG. 4. The nanoparticles used were prepared according to the method described in Example 1.

ICG solution of 50 μM was prepared by dissolving ICG in the cell culture medium and this solution was further diluted in the cell culture medium to get concentrations from 0.00022 to 50 μM. About 10 mg ICG nanoparticles were suspended in 10 mL cell culture medium to obtain 1 mg/mL nanoparticle suspension equivalent to 0.022 μM ICG concentration. This suspension was then further diluted to get the nanoparticle suspension of 0.00022 to 0.011 μM ICG concentrations. For the intracellular uptake studies, cells were seeded in 6-well cell culture plates at the concentration of 2×10⁵ in 4 ml growth medium per well. After overnight attachment the medium was replaced with ICG solution of different concentrations (0.00022-0.022 μM) or nanoparticle suspension of different concentrations (0.00022-0.022 μM) and the cells were incubated for 24 hrs at 37° C. in the dark. After 24 hrs of incubation the medium was removed and the cells were washed four times with phosphate buffer saline. ICG was then extracted from the cells in each well by incubation with 1 ml of dimethylsulfoxide (DMSO). The fluorescence of ICG in DMSO was measured and ICG concentrations were calculated by a using a calibration curve of ICG in DMSO.

### Example 4

### Relative Intracellular Uptake of Indocyanine Green (ICG), by C-33A and B16-F10 Cancer Cell Lines, when Incubated with ICG Loaded Nanoparticle Suspension

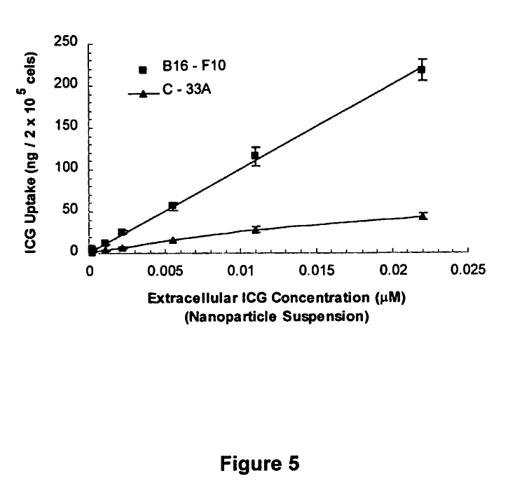

Relative intracellular uptake of Indocyanine green (ICG), by C-33A and B16-F10 cancer cell lines, when incubated with ICG loaded nanoparticle suspension is shown in FIG. 5. The nanoparticles used were prepared according to the method described in Example 1.

About 10 mg ICG nanoparticles were suspended in 10 mL cell culture medium to obtain 1 mg/mL nanoparticle suspension equivalent to 0.022 μM ICG concentration. This suspension was then further diluted to get the nanoparticle suspension of 0.00022 to 0.011 μM ICG concentrations. For the intracellular uptake studies, cells were seeded in 6-well cell culture plates at the concentration of 2×10⁵ in 4 ml growth medium per well. After overnight attachment the medium was replaced with nanoparticle suspension of different concentrations (0.00022-0.022 μM) and the cells were incubated for 24 hrs at 37° C. in the dark. After 24 hrs of incubation the medium was removed and the cells were washed four times with phosphate buffer saline. ICG was then extracted from the cells in each well by incubation with 1 ml of dimethylsulfoxide (DMSO). The fluorescence of ICG in DMSO was measured and ICG concentrations were calculated by a using a calibration curve of ICG in DMSO.

### Example 5

### PEG Coating on the Surface of Nanoparticles

Materials:

Fluorescein-Polyethylene glycol (PEG-Fluorescein), MW 5,000 Da, was obtained from Nektar (Nektar Therapeutics, San Carlos, Calif.). The nanoparticles used were prepared according to the method described in Example One.

PEG Coating on the Surface of PLGA Nanoparticles:

1. PEG-Fluorescein was dissolved in distilled water to get 0.5, 1 and 2% w/v solutions.

2. Then in 2 ml of each of the above prepared solutions, 25 mg of nanoparticles were suspended. The suspensions were incubated for 24 hours.

3. After 24 hours of incubation the nanoparticle suspensions were centrifuged at 16,000 g for 5 minutes.

4. After centrifugation the supernatant was discharged and the nanoparticles precipitate left behind was resuspended in phosphate buffer saline (PBS) for further studies.

### Example 6

### Effect of Initial PEG Concentration on the Amount of PEG Coated on Nanoparticles

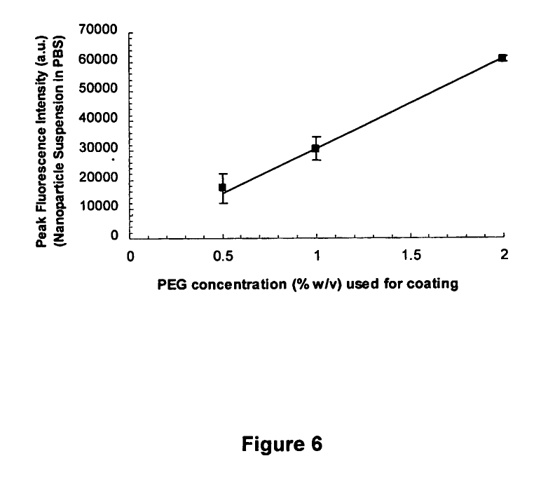

Effect of initial PEG concentration used for nanoparticle coating on the amount of PEG coated on the nanoparticles is shown in FIG. 6.

The nanoparticles used were prepared according to the method described in Example 1. The nanoparticles were incubated for 24 hours with different concentrations of PEG-Fluorescein (0.5-2% w/v) for surface coating of the nanoparticles. For measuring the fluorescence associated with the nanoparticles after coating, 1 mg of PEG-Fluorescein coated nanoparticles were suspended in 1 ml of PBS. The peak fluorescence intensity of these samples was measured at excitation wavelength of 520 nm.

We claim:

1. A polymeric nanoparticle capable of entrapping a fluorescent dye or other substance.

2. A composition containing polymeric nanoparticles entrapping a fluorescent dye or other substance.

3. The composition of claim 2, wherein the nanoparticle is comprised of a biodegradable polymer.

4. The composition of claim 3, wherein the biodegradable polymer is selected from the group consisting of: PLGA, PLA, PVA, PGA, Chitosan, Albumin, and any combination thereof.

5. The composition of claims 2 or 3, wherein the nanoparticle is about 1 to 1000 nm in size.

6. The composition of claims 2 or 3, wherein the size of the nanoparticle is in the micrometer range.

7. The composition of claims 2 or 3, wherein the fluorescent dye is indocyanine green (ICG).

8. The composition of claim 2, further comprising a targeting molecule.

9. The composition of claim 8, wherein the targeting molecule is selected from the group consisting of: an antibody, a protein, a polypeptide, a polysaccharide, DNA, RNA, a chemical moiety, a nucleic acids, lipids, carbohydrates, and any combination thereof.

10. The composition of claim 2 further comprising a pharmaceutically acceptable vehicle.

11. A method of making polymeric nanoparticles that entrap a dye or other substance, said method comprising the steps of:
a) making a solution containing the carrier polymer and the dye;
b) dispersing the above solution into a second solution where the carrier polymer will form nanoparticles;
c) allowing a nanoparticle suspension to form wherein the nanoparticles entrap the dye;
d) separating the nanoparticles from the liquid phase by centrifuging or other methods.

12. A polymeric nanoparticle-dye complex made according to the method of claim 11.

13. A kit comprising the polymeric nanoparticle-dye complex of claim 12.

14. A PLGA nanoparticle-ICG complex.

15. A contrast agent comprising a polymeric nanoparticle-near infrared dye complex.

16. The contrast agent of claim 15, wherein said agent is useful for identifying inhomogeneities within the scattering media of tissues.

17. The contrast agent of claim 16, wherein the inhomogeneities are tumors and melanine.

18. A method of stabilizing IR fluorescent dyes comprising entrapping the dye in a polymeric nanoparticle.

19. A method for treating cancer, comprising administering to a subject in need of treatment a composition comprising one or more polymeric nanoparticle-dye complexes in an amount effective to prevent, ameliorate, reduce, or eliminate cancer cells.
